(19) United States
(12) Patent Application Publication
(10) Pub. No.: US 2009/0214874 A1
(43) Pub. Date: Aug. 27, 2009

(54) ENHANCED COATING OR LAYER

(75) Inventors: Mark A. Voss, Richmond, MI (US); Mary Sue Acker, Howell, MI (US); Stanley A. Iobst, Troy, MI (US); Chen-Shih Wang, Troy, MI (US); Phuong-Anh P. Ngo, Troy, MI (US)

Correspondence Address: General Motors Corporation;c/o REISING, ETHINGTON, BARNES, KISSELLE, P.C., P.O. BOX 4390, TROY, MI, 48099-4390, US

(73) Assignee: GM GLOBAL TECHNOLOGY OPERATIONS, INC., DETROIT, MI (US)

(21) Appl. No.: 12/038,377

(22) Filed: Feb. 27, 2008

(51) Int. Cl. C08K 5/34; B32B 27/40; B32B 19/00; B32B 9/04

(52) U.S. Cl. 428/423.1; 524/92; 428/426; 428/457; 428/688; 428/411.1; 428/447

(57) ABSTRACT

One exemplary embodiment may include a coating composition including an additive to prevent or hinder at least one of the coating or an underlying substrate from destabilization upon exposure to electromagnetic radiation.

### TECHNICAL FIELD

The field to which the disclosure generally relates includes an enhanced coating, and more particularly to a coating including an additive to prevent or hinder destabilization of the coating and/or an underlying substrate upon exposure to electromagnetic radiation.

### BACKGROUND

A variety of ultraviolet light stabilizers are known.

### SUMMARY OF EXEMPLARY EMBODIMENTS OF THE INVENTION

One exemplary embodiment may include an enhanced coating over a substrate, wherein the enhanced coating includes an additive to prevent or hinder destabilization of at least one of the coating or substrate upon exposure to electromagnetic radiation.

One exemplary embodiment may include an enhanced coating over a substrate including an additive to prevent or hinder destabilization of at least one of the coating or the substrate upon exposure to electromagnetic radiation having wavelengths at or less than 435 nm.

One exemplary embodiment may include an enhanced coating over a substrate including an additive to prevent or hinder destabilization of the coating upon exposure to electromagnetic radiation in the wavelength range of 390 nm-435 nm.

Another exemplary embodiment may include a protective or decorative coating including benzotriazole over a substrate.

Another exemplary embodiment may include a coating composition comprising a polymer, a solvent, and benzotriazole.

Another exemplary embodiment may include a substrate including a polymer and a plurality of fibers wherein the polymer is prone to destabilize upon exposure to electromagnetic radiation, and a protective or decorative coating including benzotriazole over the substrate.

Another exemplary embodiment may include a method comprising: providing a coating composition comprising a polymer and a solvent, and adding benzotriazole to the coating composition.

### BRIEF DESCRIPTION OF THE DRAWINGS

Exemplary (illustrative) embodiments of the invention will become more fully understood from the detailed description and the accompanying drawings, wherein:

FIG. 1 illustrates a product including a substrate and an enhanced coating over the substrate according to one exemplary embodiment.

FIG. 2 illustrates a product including a composite substrate including a plurality of fibers, and an enhanced coating over the substrate according to one exemplary embodiment.

FIG. 3 illustrates a vehicle having a plurality of molded composite body panels susceptible to destabilization upon exposure to electromagnetic radiation and having an enhanced coating over the panels according to one exemplary embodiment.

### DETAILED DESCRIPTION OF EXEMPLARY EMBODIMENTS

The following description of the embodiment(s) is merely exemplary in nature and is in no way intended to limit the invention, its application, or uses.

One exemplary embodiment includes a protective or decorative coating composition including an organic polymer, solvent, and a first additive to prevent or hinder damage to a cured coating made therefrom and/or damage to an underlying layer or substrate upon exposure to certain wavelengths of electromagnetic radiation. In various exemplary embodiments the first additive may absorb energy from electromagnetic radiation having wavelengths ranging from 390-450 nm; above 400 nm to 450 nm; above 400 nm to 435 nm; 405-435 nm; 420-435 nm or at various wavelengths between the aforementioned outer limits of such ranges. In one embodiment the first additive may be effective in absorbing electromagnetic radiation energy in the ultraviolet-visible light range. In one exemplary embodiment, the first additive may include benzotriazole (also referred to as C₆H₅N₃; 1H-Benzotriazol; or 1,2,3-Benzotriazol).

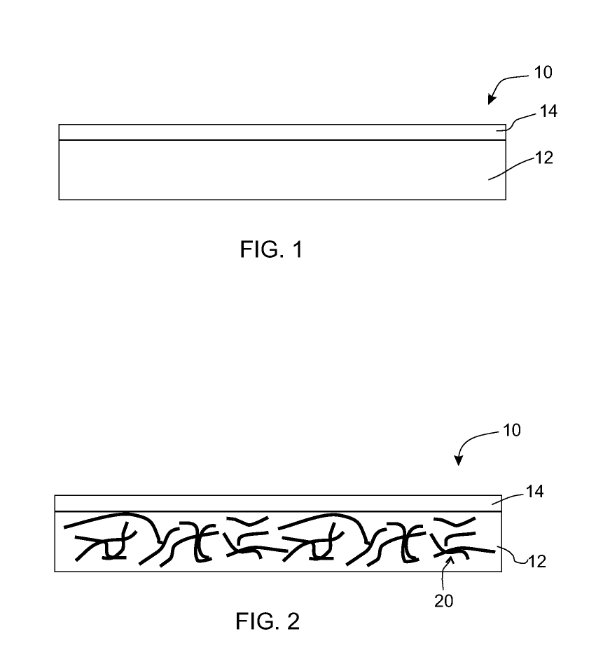

Referring now to FIG. 1, one exemplary embodiment may include a product 10 including a substrate 12, and a protective or decorative coating 14 over the substrate 12. In one exemplary embodiment the coating 14 may be applied directly on the substrate 12. In another exemplary embodiment, a plurality of additional layers may be interposed between the coating 14 and the substrate 12.

The amount of the first additive included in the composition used to make the cross-linked coating 14 may vary. In one exemplary embodiment, the first additive may be provided in an amount effective in protecting or hindering the coating 14 and/or underlying substrate 12 from damage upon exposure to electromagnetic radiation (light), particularly at wavelengths of 435 nm or less. In one embodiment, the first additive may be added to the coating 14 in an amount sufficient to prevent or hinder damage to the coating 14 and/or underlying substrate upon exposure to electromagnetic radiation in the wavelength range of 400-435 nm. In one exemplary embodiment of the invention less than 5% by weight of first additive may be included in the coating composition including a monomer and/or polymer and a solvent. In other exemplary embodiments, 3%-5%, or less than 3% by weight of additive may be added to the coating composition.

The coating composition may include any of a variety of polymers that may be cross-linked to provide a protective or decorative coating 14. Examples of such polymers include, but are not limited to acid-epoxy, urethane, melamine, carbamate, polyurethane-polyolefin, or silane. Suitable solvents for such coating compositions include, but are not limited to Naphtha, Amyl Acetate, n-Butyl Acetate, methoxypropanol, or Aromatic 100 Hydrocarbon.

A suitable clear coat composition for use in making a coating 14 according to one embodiment of the invention is available under the trade name Autoclear III, from Akzo Nobel company. One exemplary embodiment may include a method composing providing a coating composition comprising a polymer and a solvent, and adding benzotriazole. A substrate may be covered with the coating composition and the coating composition cured by the application of heat to provide a solid protective or decorative coating adhered to the substrate.

In another exemplary embodiment, if desired, a second additive such as color shift additive may be included in the coating composition to change the color of the coating 14 or to make the coating 14 color neutral. For example, when benzotriazole is added to a polymeric coating composition, the composition may turn slightly yellow. A red-based pigment may be added to nullify the color associated with the addition of benzotriazole to produce a relatively clear coating 14, such as a clearcoat. For example, when 3% by weight of benzotriazole is added to a polymeric coating composition including a solvent, approximately 0.3% of a red pigment may be added to produce a clear coating 14 upon curing of the coating composition. In one embodiment of the invention about 0.01 to 0.5 weight percent of a color shift additive may be included in the coating composition.

However, other pigments may be added to shift the color of the coating produced with the benzotriazole additive thereby producing a colored or tinted protective or decorative coating 14 over a substrate 12. The coating composition may be applied to a substrate using a variety of techniques known to those skilled in the art including, but not limited to spraying the coating composition onto the substrate 12.

The substrate 12 may be any of a variety of materials including, but not limited to a metal, wood, polymer, ceramic, stone or composite material. In one exemplary embodiment, the substrate 12 may be a cosmetic composite panel with visible fibers formed by molding a fiber mat, such as fiberglass and/or carbon fibers, with a resin or binding material. A suitable resin may include, but is not limited to, a diglycidyl ether of bisphenol-A. The most commonly used diglycidyl ether of bisphenol-A epoxy resin, however, is susceptible or prone to destabilization upon exposure to electromagnetic radiation in the ultraviolet and ultraviolet-visible light range. The destabilization is resulted from photo-oxidation reactions initiated by the electromagnet radiation at or near the aromatic groups contained in the resin molecules. The carbonyl groups in the molecules have also been found to show high absorptivities at wavelengths near 300 nm. If the resin or binding material is not protected from destabilization, the substrate 12 may change color and eventually the clearcoat 14 thereon may delaminate. Numerous attempts have been made in the literature to prevent or hinder the photo-oxidation caused destabilization of the diglycidyl ether of bisphenol-A epoxy resin by using various UV absorbers or stabilizers. The efforts, unfortunately, have not been successful.

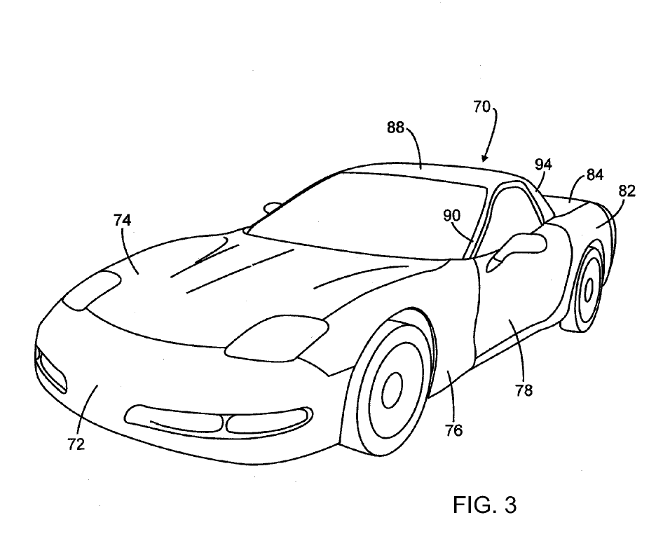

The substrate 12, as illustrated in FIGS. 1-2, may be a structural component of any of a variety of products. For example, the substrate may be a wood plank floor, a deck, house panels or the like. In other forms, the substrate 12 may be a tennis racket, bicycle, outdoor chair, fence, sporting goods, sail boards, surf boards, or golf clubs. The coating 14 may be applied to a variety of polymer or composite products including, but not limited to, outdoor pool furniture, house siding, mailboxes, boat, land vehicles such as, but not limited to truck and automobiles, motorcycles and airplanes.

Referring now to FIG. 3, one exemplary embodiment may include a vehicle having a plurality of molded fiber composite panels such as a fascia 72, engine hood 74, front quarter panel 76, door 78, rear quarter panel 82, rear trunk deck 84, pillars 90, 94 or roof 88. Each of the molded fiber composite panels may include a coating 14 including a first additive according to one embodiment of the invention. Aftermarket product such as, but not limited to, rocker panel, interior or exterior trim, spoilers, door handles, mirror covers, air diffusers, or fascia extensions may include a coating 14 including a first additive according to one embodiment of the invention.

In a number of exemplary embodiments the substrate 12 may include no pigment or not enough pigment to protect the substrate from destabilizing upon exposure to electromagnetic radiation in the ultraviolet and/or visible light range.

A cosmetic composite panel useful in various exemplary embodiments may be made by a variety of methods. The following description is illustrative of a few of such methods. Such a method may involve autoclave molding of a hand lay-up of fiber-epoxy prepreg using a single-sided metal or composite tool. The panels may be produced by first cutting the prepregs to the shape of the part using an automated pattern-cutting machine. A predetermined number of plies of the patterned prepregs may be manually laid up in the tool cavity, and covered and sealed with a silicone rubber vacuum bag to evacuate the air trapped between the plies. The assembled prepreg plies may be subsequently consolidated and cured in an autoclave at an elevated temperature under pressure for a given period of time. The autoclave then may be cooled down and depressurized for the cured prepregs to be removed from the single-sided tool. The cured prepregs are trimmed, inspected, and finished to produce the final composite panels.

Another method of making cosmetic composite panels may involve resin transfer molding of fiber preforms in a matched-metal or composite tool. The fiber preforms can be made by heating and pressuring patterned lay-ups prepared from continuous random fiber mats, unidirectional fiber tapes, or woven fiber fabrics. The fiber preforms can also be made by directly spraying chopped fibers onto a preform mold or by depositing chopped fibers onto a perform mold using a water or liquid slurry process. The shaped fiber preforms may be placed in the matched-metal or composite tool and the epoxy resins are subsequently injected into the closed tool cavity. The tool may be kept at an elevated temperature under pressure for a given period of time to impregnate the fibers with epoxy resins and to form the cured composite panels.

A typical automotive fiber-epoxy prepreg material which may be utilized according to one exemplary embodiment is the P831-190 carbon fiber-epoxy prepreg produced by Toray Composites. The prepreg is made with Toray's T-600 24k unidirectional carbon fiber (60 wt %) and G83C epoxy resin (40 wt %). Similar commercial prepreg materials, in both unidirectional tape and woven fabric forms, are available from prepreg suppliers such as Advanced Composites Group (ACG) and Hankuk Carbon Company using carbon fibers produced by Toray, TohoTenax, Zoltek, etc. The prepregs can be cured at 150° C. (peak temperature) under 0.7 MPa pressure for 10 minutes. A full cycle of the autoclave molding takes approximately 90 minutes to complete. The molding cycle consists of loading, pressurizing, ramping up to 150° C., cooling down, depressurizing, unloading and demolding.

According to another exemplary embodiment, a coating 14 was made from a coating composition with benzotriazole added thereto, and the resultant cured coating 14 on a carbon fiber-epoxy substrate 12 was tested and found to met all of the performance standards of GMW14873: Outdoor Exposure (July 2007); SAEJ1960: Xenon Weatherometer.

Additionally, it should be noted that the compositions disclosed in this submission are representative. The compositions are expected to work as well or better within a range of the concentration of each component.

1. A coating composition for forming a protective or decorative coating over a substrate comprising:
a polymer or monomer, a solvent, and an additive capable of absorbing energy from electromagnetic radiation having wave lengths in the ultraviolet light and visible light range.

2. A composition as set forth in claim 1 wherein the additive comprises benzotriazole.

3. A composition as set forth in claim 1 wherein the additive is present in an amount equal to or less than 5 weight percent of the composition.

4. A composition as set forth in claim 1 wherein the additive is present in an amount ranging from 3-5 weight percent of the coating composition.

5. A composition as set forth in claim 1 wherein the benzotriazole is present in an amount equal to or less than 3% by weight of the coating composition.

6. A composition as set forth in claim 1 wherein the polymer comprises an acid-epoxy.

7. A composition as set forth in claim 1 wherein the polymer comprises a polyurethane.

8. A composition as set forth in claim 1 wherein the polymer compromises a melamine.

9. A composition as set forth in claim 1 wherein the polymer comprises an carbamate.

10. A composition as set forth in claim 1 wherein the polymer comprises a polyureathane-polyolefin.

11. A composition as set forth in claim 1 wherein the polymer compromises a silane.

12. A composition as set forth in claim 1 further comprising a color shift additive in an amount sufficient to make the coating composition clear or tinted.

13. A product comprising:
a substrate and a protective or decorative coating over the substrate, the coating comprising a cured polymer and a first additive capable of absorbing energy from electromagnetic radiation having wave lengths in the ultraviolet light and visible light range, wherein the first additive comprises benzotriazole having the chemical formula C₆H₅N₃ in an amount equal to or less than 3% by weight of the cured polymer.

14. (canceled)

15. (canceled)

16. A product as set forth in claim 13, wherein the substrate comprises a metal, a polymer, wood, ceramic, stone or a composite.

17. A product as set forth in claim 13 wherein the substrate comprises a molded fiber composite panel susceptible or prone to destabilization upon exposure to ultraviolet light and visible light.

18. A product as set forth in claim 17 wherein the product comprises a land vehicle.

19. A product as set forth in claim 17 wherein the product comprises a boat.

20. A product as set forth in claim 13 wherein the cured coating comprises an acid-epoxy polymer.

21. A product as set forth in claim 13 wherein the cured coating comprises a polyurethane.

22. A product as set forth in claim 13 wherein the cured coating comprises a melamine.

23. A product as set forth in claim 13 wherein the cured coating comprises carbamate.

24. A product as set forth in claim 13 wherein the cured coating comprises a polyurethane-polyolefin.

25. A product as set forth in claim 13 wherein the cured coating comprises a silane.

26. A product as set forth in claim 17 wherein the substrate does not include additional pigment to protect the substrate from the destabilization upon exposure to electromagnetic radiation.

27. A method composing:
providing a coating composition comprising a polymer and a solvent, and adding benzotriazole to the composition.

28. A method as set forth in claim 27 wherein the benzotriazole is added in an amount equal to or less than 5% by weight of the coating composition.

29. A method as set forth in claim 27 wherein the benzotriazole is added in an amount ranging from 3%-5% by weight of the coating composition.

30. A method as set forth in claim 27 wherein the benzotriazole is added in an amount equal to or less than 3% by weight of the coating composition.

31. A method as set forth in claim 27 further comprising adding a color shift additive to the coating composition to make the coating clear or a different color than that associated with the coating composition having only the benzotriazole therein.

32. A method as set forth in claim 27 further comprising covering a substrate with the coating composition and curing the coating composition.

33. A method as set forth in claim 32 wherein the substrate comprises of at least one of a metal, polymer, wood, ceramic or composite material.

34. A vehicle comprising:
at least one fiber composite panel comprising a substrate comprising a binding material susceptible to destabilization upon exposure to electromagnetic radiation in the ultraviolet light and visible light ranges, and a protective or decorative coating over the substrate, the coating comprising a first additive capable of absorbing energy from electromagnetic radiation having wave lengths in the ultraviolet light and visible light range.

35. A vehicle as set forth in claim 34 wherein the first additive comprises benzotriazole.

36. A vehicle as set forth in claim 35 wherein the coating does not include an additional pigment in an amount sufficient protect the substrate from destabilization upon exposure to said electromagnetic radiation without the first additive.
